(19) United States
(12) Patent Application Publication
(10) Pub. No.: US 2020/0307783 A1
(43) Pub. Date: Oct. 1, 2020

(54) Compact Transformable Robot

(71) Applicant: Robotic Research, LLC, Gaithersburg, MD (US)

(72) Inventors: Alberto Daniel Lacaze, Potomac, MD (US); Karl Nicholas Murphy, Rockville, MD (US)

(73) Assignee: Alberto Daniel Lacaze, Gaithersburg, MD (US)

(21) Appl. No.: 16/542,807

(22) Filed: Aug. 16, 2019

Related U.S. Application Data
(60) Provisional application No. 62/824,359, filed on Mar. 27, 2019.

(51) Int. Cl. B64C 39/02; B64C 37/00

(52) U.S. Cl. CPC B64C 39/02; B64C 37/00; B64C 2201/024; B64C 2201/22; B64C 2201/108; B64C 2201/126; B64C 2201/145; B64C 2201/102

(57) ABSTRACT

The invention pertains to the development of a unique and small transformable robot that will fit into very small pipes, openings, or packing tubes, thereby enabling complex missions and also which can fly and drive. Other advantages of the system include portability, weight, perch, and stare capabilities. The present invention comprises a compact transformable robot capable of flying and driving designed to furl or fit into small openings, containers, packing tubes, or pipes containing a thrust, a main body, controls, and rotating propellers. The compact transformable robot capable of flying and driving that is designed to furl or fit into small openings, containers, or pipes comprises a ground locomotion, an aerial locomotion, controls, sensors, and a radio.

### CROSS-REFERENCE TO RELATED APPLICATIONS

2018/0117980

### BACKGROUND OF THE INVENTION

### 1. Field of the Invention

The present invention involves the development of a unique and small transformable robot that will fit into very small pipes, openings, containers, or packing tubes, thereby enabling complex missions and also which can fly and drive. Other advantages of the system include portability, weight, perch, and stare capabilities. The design involves the development of a compact transformable robot capable of flying and driving that is designed to furl or fit into small openings, containers, packing tubes, or pipes and which contain a thrust, a main body, controls, and rotating propellers. The compact transformable robot that is capable of flying and driving is designed to furl or fit into small openings, containers, or pipes and comprises a ground locomotion, an aerial locomotion, controls, sensors, and a radio.

### 2. Description of Related Art

The statements in this section mostly provide background information related to the present disclosure and may not constitute prior art.

There is a great need for small transformable robots fitting into very small openings that can undergo multiple varieties of locomotion such as flying and driving for different applications. There have not been any reports of these types of robots that have been developed in the patent literature.

One might ask, why not simply use a helicopter design? The compact transformable robot in the present invention is significantly simpler than a helicopter design since the propellers are not changing their pitch as they spin. Helicopters need to have the correct pitch at each angle around the helicopter to control the forward and side to side maneuvers. This mechanism is the Achilles Heel of all RC helicopters. Small scale helicopter designs are usually hard to control and significantly more complicated to maintain.

There have been several patents related to locomotion of legged robots and are transformable robots, but none of them are related to robots that can fly and drive and fit into very small openings, pipes, packing tubes, and containers.

There has been a patent which discloses an invention related to the development of robotic systems for modeling, mapping, and exploring subterranean voids that is generally enabled by a procedural system consisting of preprocessing, ingress, void modeling, mapping, and navigation, exploration, conveying payloads other than void modeling sensors, egress, and postprocessing. These robots that are developed can transform from a compact size to a more conventional operating size if the operating size exceeds the void entry opening size. This invention is discussed in U.S. Pat. No. 7,069,124. It is worth noting that in this invention, there is no ability to fly and drive into very small openings, containers, packing tubes and pipes as described in the present invention since the previous invention is not a compact transformable robot.

A transformable aerial vehicle has been developed which has a central body and at least two transformable frames assemblies respectively that are disposed on the central body, in which at least two transformable frame assemblies have a proximal portion pivotally coupled to the central body and a distal portion; an actuation assembly mounted on the central body and configured to pivot the at least two frame assemblies to a plurality of different vertical angles relative to the central body; and a plurality of propulsion units mounted on the at least two transformable frame assemblies and operable to move the transformable aerial vehicle. This invention has been disclosed in U.S. Pat. No. 9,242,729. Nothing in this invention is related to a compact transformable vehicle that can fly and drive into very small openings, containers, packing tubes, and pipes.

There has been a transformable vehicle that has been developed that has a central chassis assembly with a first and second distal ends with an axis passing in between, a first wheel assembly mounted to the first distal end, and a second wheel assembly mounted to a second distal end. This consists of a multifunction transformable vehicle comprising at least two configuration states which are the stowed state and the transformed state. This invention disclosure is discussed in U.S. Pat. No. 6,502,657. It is worth mentioning that this disclosure does not deal with a transformable vehicle that can fly and drive into very small openings and pipes.

There have been no reports on the development of a compact transformable robot that has the capabilities of multiple varieties of locomotion such as the capability to fly and drive and to furl and fit into very small openings, containers, pipes, and packing tubes.

### SUMMARY OF THE INVENTION

The present invention involves the development of a compact transformable robot that can fit into small openings such as very small pipes and also fly and drive and undergo various modes of locomotion.

It involves the development of a compact transformable robot that is designed to furl or fit into small openings containers, or pipes that has the capability to both fly and drive which comprises a ground locomotion, an aerial locomotion, controls, sensors, and a radio.

### BRIEF DESCRIPTION OF THE DRAWINGS

The present invention is described in the detailed description that follows, with reference to the following noted drawings that illustrate non-limiting examples of embodiments of the present invention, and in which like reference numerals represent similar parts throughout the drawings.

FIGS. 1A and 1B—illustrates the hybrid UAV/UGV fitting inside a pipe opening.

FIG. 2—illustrates a UAV that flies

FIG. 3—illustrates a UGV that drives. The UAV and UGV should be combined to show one vehicle (hybrid UAV/UGV) that flies and drives. This results in a transformable vehicle that both flies and drives.

FIG. 4—shows the top view of the rotor arms folding inward for storage.

FIG. 5—shows the front cross-sectional view of the vehicle's tracks.

### DETAILED DESCRIPTION OF THE INVENTION

Elements in the Figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

Unless specifically set forth herein, the terms “a,” “an,” and “the” are not limited to one element, but instead should be read as meaning “at least one.” The terminology includes the words noted above, derivatives thereof, and words of similar import.

The particulars shown herein are given as examples and are for the purposes of illustrative discussion of the embodiments of the present invention only and are presented in the cause of providing what is believed to be the most useful and readily understood description of the principles and conceptual aspects of the present invention.

There is always a wall blocking the way. As with many of the locations where warfighters operate, there is almost always a wall protecting the area of interest. The compact transformable robot developed here can quickly fly over the wall, land at the center of the compound, and look for improvised explosive devices, IEDs, in the area (i.e. doorways, etc.). It can also be flown again and perched on a roof, pointing to entry points where fighters could be hiding. In addition, when compact transformable robot flies to the building, it can inspect windows and land inside, or on the roof and employ sensors to collect and pass vital information to the force.

Asset recovery is simplified. The Department of Defense (DoD) has created families of “throwable” systems designed to be tossed over the impeding wall. However, a robot that is “throwable” is not usually a competent ground vehicle. Moreover, there is nobody on the other side to “throw it back.” Therefore, warfighters often need to enter dangerous areas in order to recover the asset. Pegasus-M is able to use its propellers if it gets stuck, it is capable of traversing terrains that are impassable by ground vehicles, and there is no need to put the warfighter at risk to recover the asset since it can usually fly back on its own.

There is access to areas that are inherently unreachable to robotic vehicles. Many indoor scenarios and underground facilities pose challenges to robotic systems. For example, it is easier and faster to drive indoors in constrained areas, but it may be easier to fly in larger areas. The platform allows for the sequential use and full exploitation of the dual modalities.

When flying, UAVs are loud, easily alerting enemies of their location. However, the compact transformable robot we have developed, in its ground modality, is orders of magnitude quieter than flying UAVs. This allows it to excel in missions where maintaining a low acoustic signature is important.

The compact transformable robot can drive for approximately 6 hours. Therefore, its mission durations can be significantly longer when the vehicle is mostly traversing in ground mode. This becomes important if the ISR mission has significant indoor components. UAVs are clumsy and noisy indoors, and because their battery life in flight mode is relatively short, mapping or searching a large indoor area is usually not possible. The compact transformable robot, with its ground capabilities, can cover significant amount of indoor areas, and still conserve battery to fly back.

Because the compact transformable robot can perch in a location for long periods of time, it can provide the long-term sensor that is needed for many operations. The onboard batteries can power the computer and sensors (cameras) for days. If low power modes are used (the system is already capable of doing this), the batteries could last for weeks. For example, a “perch” behavior could be implemented where all motors, and even radios, are turned off; it would only transmit when the cameras see motion, or at certain designated times. These modalities are relatively simple to implement and could further increase the capabilities of the platform.

Mapping can be performed with base platform sensors on a single vehicle and also, they can be integrated into a real-time multivehicle situational awareness tool. A group of compacts generated this map and populated it with live video. Because these maps were generated using photogrammetry, the same mapping capabilities can be used in the compact transformable robot.

At the core of the compact transformable robot that has been developed is the SR-NAV board, which is designed to interface with the NVIDIA TX2 Jetson System on Module. The board has an IMU, Ranging Radio, Ethernet Switch, SD card reader, and a microprocessor. FIG. 3 shows an image of the top view of the SR-NAV board which is the hardware that is used for the compact transformable robots.

Accurate localization in GPS-denied areas has already been established using very similar technology. Specifically, a group of ICE operators used this technology to localize inside of a drug tunnel. In addition to the ranging sensors and the IMU, optical flow algorithms are utilized for GPS-denied localization. Our flow algorithm automatically selects features in the image to track, and then tracks them across successive images to compute the relative distance travelled by the platform between the frames.

Anchor nodes have been developed for navigational aids that support the SR-NAV board. Currently, the nodes contain a low-cost IMU and a ranging radio. This ranging radio allows for the localization of multiple vehicles to tie together. The vehicles can use these anchor nodes to improve their location and four of these devices have been used in each manned vehicle to automatically create relative localization between the larger vehicles and the smaller platforms. These anchor nodes can be used to mark areas where the system needs to land.

The base platform has teleoperation, waypoint following (without obstacle avoidance), visual odometry enhanced position hold, and a variety of methods for maintaining accurate elevation (barometer, single point laser rangefinder, and acoustic sensor).

Accurate teleoperation has been demonstrated with long communication delays. This level of functionality will become important when multiple radio hops are used, or when there is interest in minimizing bandwidth. Other than the fact that the GFE SATCOM radio will consume most of the payload capability, there are no other hardware changes.

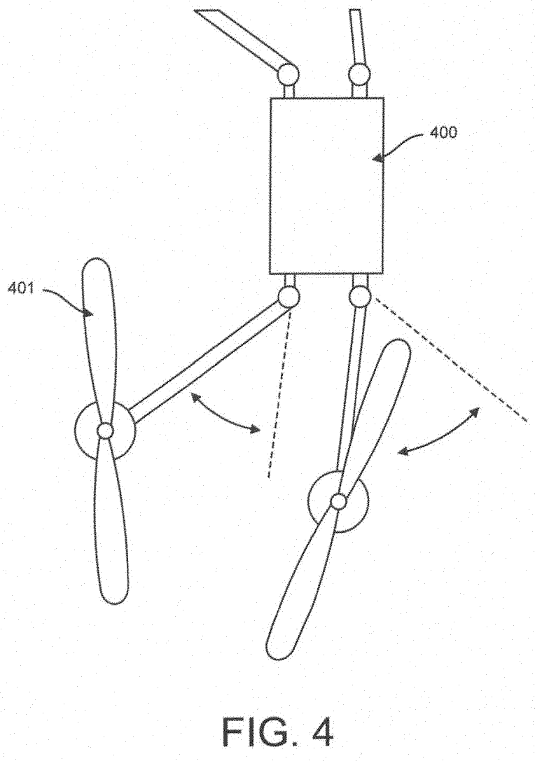

A small transformable robot has been developed which can teleoperate with long communication delays. In this case, the image shown at the OCU is delayed by 590 ms. The operator “drives” the simulated white box depicted on this image shown in FIG. 4 as opposed to driving from the image itself). The white box moves based on a local simulator (at the OCU), and the vehicle is not sent the actual joystick commands; instead, it is asked to stay inside the white box. The local closed loops (at the vehicle which are not subject to the communication delay) then control the vehicle to stay inside the “white box.” The position of the white box is computed locally by the vehicle as an offset to the image shown to the operator 590 ms ago.

A unique small platform compact transformable robot that weighs 5 pounds or less and that will autonomously map, in 3D, the interior of a structure has been developed. This platform is a transformable robot that is capable of driving and flying.

The compact transformable robot system is designed for swarming from the ground up and a common OCU which displays in ATAK and NettWarrior is used in this type of robot. A variety of flight controllers and operator interfaces have been developed for drones and rotorcrafts that meet most of the requirements of this topic. In particular, for our SOCOM customer, Robotic Research has developed a Pegasus OCU (DTRA and ARDEC management). This platform includes all the software and electronics necessary to safely fly the vehicles. In particular, the systems can perform obstacle avoidance, fly in GPS denied areas and they are already integrated into ATAK/NettWarrior. This integration provides functionality into fire controls toolkits as well.

The compact transformable robot has characteristics uniquely suited for SubT missions and shows its results of localization and mapping to achieve access to areas that were previously unreachable by single modality platforms. The design of compact transformable robot will fit in an 8″ pipe, very small openings, or possibly being packed into a tube, thereby enabling complex missions. Other advantages of the system include portability, weight, perch, and stare capabilities.

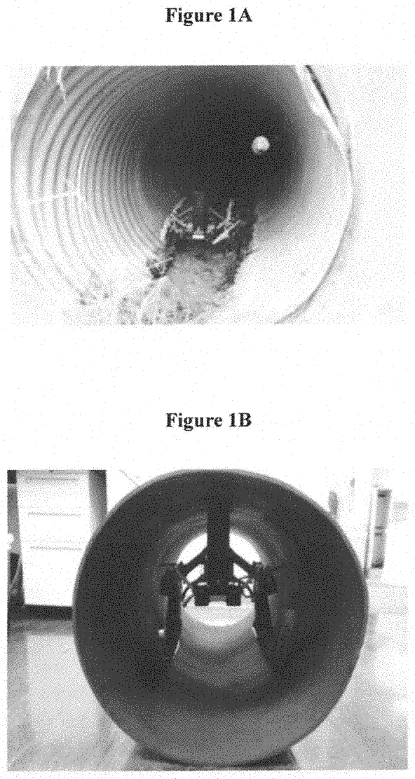

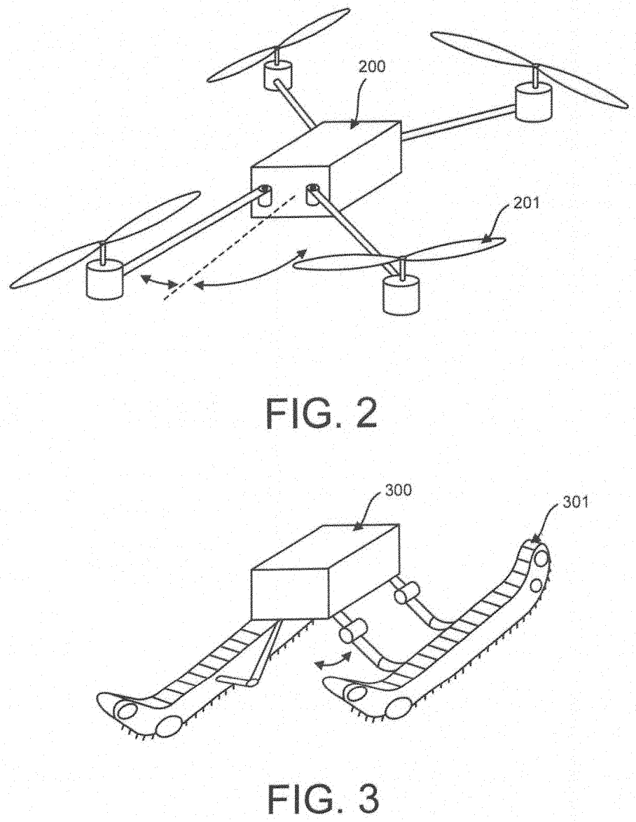

The compact transformable robot that is developed is a new design that will allow the vehicle to automatically furl and unfurl to fit in a significantly smaller opening. Specifically, the system will fit an 8″ diameter pipe (with a goal of 6″). FIGS. 1 and 2 show different views of the compact transformable robot that has been developed. The compact transformable robot is 18″ by 12″ in its unfurled position, and just 6 in diameter when stowed. It has two counter-rotating 16 in propellers to provide lift, and four small propellers for control. The overall system is approximately 7 lbs. in weight, and this includes the batteries.

The efficiency of propellers is proportional to their diameter. In other words, if we were to take a design like the previous transformable robot that is regular sized and make all components ½ scale in size (including sensors, electronics, and batteries), its flight time would decrease from 20 minutes to ˜5 minutes. This is because not only do the propellers get proportionally smaller, their efficiency drops. The design used for the compact transformable robot uses two large 18″ propellers to provide efficient thrust. These propellers are very efficient at that weight. If initial calculations are correct, the system will be able to fly close to 20 minutes.

Why not a helicopter design? The compact transformable robot is significantly simpler than a helicopter design since the propellers are not changing their pitch as they spin. Helicopters need to have the correct pitch at each angle around the helicopter to control the forward and side to side maneuvers. This mechanism is the Achilles Heel of all RC helicopters. Small scale helicopter designs are usually hard to control and significantly more complicated to maintain.

The unfurling procedure has a series of advantages. First, the ground modality will still be operational in the stowed position. Second, we expect that the unfurling process will self-right the vehicle. For example, if the vehicle drops from a pipe into the ground and just happens to fall upside down, the unfurling procedure will self-right the vehicle. Lastly, the rubber tracks fully encompass the vehicle in the stowed position, and therefore, they protect the propellers, body and payloads from a fall. We believe that this is important if the vehicle may be deployed from a pipe (aka Lethal Doormat).

As mentioned earlier, this is a new capability. Current vehicles cannot access the locations discussed above without human help. The proposed system will project forward and will increase separation with danger in ways that previous systems cannot. Although not the focus of this research, the compact transformable robot already has a well-developed Situational Awareness toolset that can further help the operator reach the location before the manipulation tasks begin.

This invention relates to the development of a compact transformable robot capable of flying and driving designed to furl or fit into small openings, containers, or pipes that comprise a ground locomotion, an aerial locomotion, controls, sensors, and a radio.

Ground locomotion refers to movement by ground while aerial locomotion refers to movement by air.

The compact transformable robot is designed to furl or unfurl or fit into cylindrical containers or pipes. Furling involves rolling or folding up and secured neatly. Unfurling involves making or becoming spread out from a rolled or folded state to be open to the wind.

The compact transformable robot is designed to fit into pipes, openings, or packing tubes. The compact transformable robot can fly over the wall, and land in the center of the compound, and look for improvised explosive devices (IEDs).

An improvised explosive device (IED) is a type of unconventional explosive weapon that can take any form and be activated in a wide variety of different ways. They target soldiers and civilians alike. In today's conflicts, IEDs play an increasingly important role and will continue to be part of the operating environment for future military operations.

The compact transformable robot can be flown and perched on a roof and can inspect windows and land inside, or on the roof, and employ sensors to collect and pass on vital information.

The compact transformable robot uses its propellers if it gets stuck and can change ground pressure or the ground locomotion mechanism, either light or heavy.

Optical flow algorithms are used for GPS-denied localization which selects features in the images in the images to truck and compute the relative distance travelled by the platform between the frames. The term optical flow is used by roboticists, encompassing related techniques from image processing and control of navigation including motion detection, object segmentation, time-to-contact information, focus of expansion calculations, luminance, motion compensated encoding, and stereo disparity measurement.

GPS refers to global positioning system and it is a satellite-based navigation system that is made up of at least 24 satellites. GPS works in any weather conditions, anywhere in the world, 24 hours a day, with no subscription fees or setup charges. The U.S. Department of Defense (USDOD) originally put the satellites into orbit for military use, but they were made available for civilian use starting in the 1980s.

The compact transformable robot is significantly quieter than the flying UAVs in its ground mode.

Anchor nodes have been developed for navigational aids with a low-cost IMU and a ranging radio. An anchor is the visible region which must be selected to activate the link. These may vary in size from one word to the entire contents of the node.

IMU refers to inertial measurement unit and is an electronic device that measures and reports a body's specific force, angular rate, and sometimes the orientation of the body, using a combination of accelerometers, gyroscopes, and sometimes magnetometers.

A ranging radio gives radio frequency (RF) measurements representing the oscillation rate of electromagnetic radiation spectrum, or electromagnetic radio waves, from frequencies ranging from 300 GHz to as low as 9 kHz.

FIG. 1A and FIG. 1B show figures of the hybrid UAV/UGV which easily fits into the small openings of pipes.

FIG. 2 shows a UAV (200) containing propellers (201) which flies while FIG. 3 shows a UGV that drives. The two robots should be combined together to form one transformable vehicle, the UAV/UGV, which flies and drives. The rotor arms can fold inward and the tracks can fold upward allowing the vehicle to fit into a small diameter piper or storage tub as can be seen in FIG. 1A and FIG. 1B.

FIG. 4 shows the top view of the rotor arms of the hybrid UAV/UGV (400) and its propellers (401) folding inward for storage purposes.

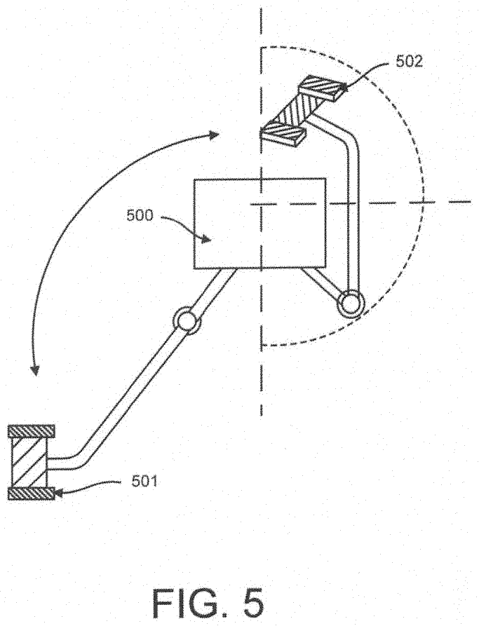

FIG. 5 shows the front cross-sectional view of the vehicle's tracks of the hybrid UAV/UGV (500). The right track (502) is in the folded position and the left track (501) is in the deployed position. The dashed circle shows the compactness of the vehicle in the furled position.

The embodiments of the invention in which an exclusive property or privilege is claimed as defined as follows:

1. A compact transformable robot capable of flying and driving designed to furl or fit into 8-inch openings, containers or pipes comprising:
ground locomotion;
aerial locomotion;
controls;
sensors; and
radio.

2. The compact transformable robot of claim 1 further comprising being designed to furl or unfurl or fit into cylindrical containers or pipes.

3. The compact transformable robot of claim 1 further comprising being designed to fit into pipes, openings, or packing tubes.

4. The compact transformable robot of claim 1 wherein the robot can fly over the wall, land at the center of the compound, and look for improvised explosive devices (IEDs).

5. The compact transformable robot of claim 1 wherein the robot can be flown and perched on a roof.

6. The compact transformable robot of claim 1 wherein the robot can inspect windows and land inside, or on the roof and employ sensors to collect and pass on vital information.

7. The compact transformable robot of claim 1 wherein the robot uses its propellers if it gets stuck and can change ground pressure or the ground locomotion mechanism (light or heavy).

8. The compact transformable robot of claim 1 wherein in its ground modality, is significantly quieter than flying UAVs.

9. The compact transformable robot of claim 1 wherein optical-flow algorithms are utilized for GPS-denied localization which selects features in the images to track and compute the relative distance travelled by the platform between the frames.

10. The compact transformable robot of claim 1 wherein anchor nodes have been developed for navigational aids with a low-cost IMU and a ranging radio.

11. The compact transformable robot of claim 1 wherein the robot can teleoperate with long communication delays.

12. The compact transformable robot of claim 1 wherein the unfurling process will self-right the vehicle.

13. The compact transformable robot of claim 1 wherein the rubber tracks fully encompass the vehicle in the stowed position and protect the propellers, body, and payloads from a fall.
